(19) United States
(12) Patent Application Publication
(10) Pub. No.: US 2009/0219139 A1
(43) Pub. Date: Sep. 3, 2009

(54) Power Harvesting for Actively Powered RFID Tags and Other Electronic Sensors

(75) Inventor: Raymond J. Slesinski, Arnold, MO (US)

Correspondence Address: LEE & HAYES, PLLC, 601 W. RIVERSIDE AVENUE, SUITE 1400, SPOKANE, WA, 99201, US

(73) Assignee: The Boeing, Chicago, IL (US)

(21) Appl. No.: 12/039,691

(22) Filed: Feb. 28, 2008

(51) Int. Cl. H04Q 5/22

(52) U.S. Cl. 340/10.1

(57) ABSTRACT

Material conveyance devices with actively powered Radio Frequency Identification (RFID) tags are described herein. The material conveyance devices motion is converted to electrical energy which is used to either recharge the RFID tags energy storage device or directly power the RFID tag.

### FIELD OF THE DISCLOSURE

The present disclosure relates to Radio Frequency Identification systems, and more specifically to material conveyance devices with actively powered Radio Frequency Identification tags.

### BACKGROUND

To support the worlds growing consumer market, there is an unprecedented need to track the flow of products as they are manufactured in one country, transported across the world, and then consumed in another country.

Traditionally, manufactures, distributors, and retailers have relied on bar code labels to track their products and manage their inventories. While barcode labels have many advantages including low cost, they also have several disadvantages. For example, the product must be in a specific orientation and the reader must be in close proximity for the barcode label to be read. Moreover, printed bar codes labels are limited by the amount of data that they can store.

Radio Frequency Identification (RFID) provides the ability to store and retrieve significant amounts of information about a product. Moreover, the information can be retrieved at high transfer rates, at significant distances from the product, and from multiple tags simultaneously. As a result, Radio Frequency Identification tags provide a unique ability to track a product from the time it is manufactured until the time it is consumed.

Radio frequency identification relies on storing and retrieving data using Radio Frequency Identification (RFID) tags. RFID tags are typically attached or incorporated into products for the purpose of identifying and tracking the product (e.g., a compact disk, a book, or clothing, to name a few). RFID tags typically include an integrated circuit and an antenna. The integrated circuit stores and processes data, modulates and demodulates an RF signal, and in some instances performs other functions (e.g., monitor the products transportation environment). Meanwhile, the antenna receives signals that have been transmitted by a host device and transmits signals which are used to identify and track the RFID tag.

RFID tags are generally grouped into three categories: passive, active, and semi-passive, also know as battery assisted.

Passive tags do not have an internal power source and instead rely on inducing an electrical current in the tags antenna from the readers' incoming RF signal. Passive tags have typically limited transmission distances (i.e., four inches to a few feet) depending on the tags operating frequency and the antenna design.

Semi-passive tags are similar to active tags in that they have their own power source, but the battery only powers the micro-chip and does not broadcast a signal. Semi-passive tags reflect back the readers RF energy, just like a passive tag.

Active tags require some type of power source, typically a battery, to power the micro-chip and broadcast the signal to the reader. Active tags are typically much more reliable than passive tags do to their ability to communicate with the reader for longer periods of time. Active tags also transmit at higher power levels than passive tags, which allows them to be read at much greater distances (i.e., up to 1500 feet). Given their greater reliability, greater range, and longer communications time, active tags have many advantages over passive tags.

However, given the time it takes to manufacture, distribute, and sell a product, an active tag may run out of battery power before the product has reached its final destination or has been sold. Accordingly, there is a need for an active RFID tag with a longer life.

### SUMMARY

Techniques for actively powering a radio frequency identification tag are described herein.

In one implementation, a material conveyance device includes a structure for transporting material and a radio frequency identification device. The radio frequency identification device includes an energy storage device for supplying electrical energy to a radio frequency transceiver, a power generation device for supplying electrical energy to the energy storage device, and a power regulator for regulating the electrical energy generated by the power generation device.

In another implementation, a method for tracking material being transported by a material conveyance device may include receiving an interrogation signal and transmitting a signal in response to the interrogation signal, the signal being transmitted by the material conveyance device in response to the interrogation signal. The material conveyance device may include a power generation device for converting kinetic energy into electrical energy and a radio frequency transceiver for receiving the interrogation signal and transmitting the signal using electrical energy generated by the power generation device.

Other systems, methods, and/or devices according to other embodiments will be or become apparent to one with skill in the art upon review of the following drawings and detailed description. It is intended that all such additional systems, methods, and/or devices be included within this description, be within the scope of the present disclosure, and be encompassed by the accompanying claims.

This summary is not intended to identify the essential features of the claimed subject matter, nor is it intended to determine the scope of the claimed subject matter.

### BRIEF DESCRIPTIONS OF THE DRAWINGS

The disclosure is made with reference to the accompanying figures. In the figures, the left most reference number identifies the figure in which the reference number first appears. The use of the same reference numbers in different figures indicates similar or identical terms.

FIG. 1 illustrates a radio frequency identification tag with active power generation.

FIG. 2 illustrates a system for tracking material being transported by a material conveyance device.

FIG. 3 illustrates a radio frequency identification tag which has been integrated into a wheel.

FIG. 4 illustrates a device for converting linear motion into electrical energy.

FIG. 5 illustrates a device for converting angular motion into electrical energy.

FIG. 6 illustrates a method for determining the location of a material conveyance device.

### DETAILED DESCRIPTION

The present disclosure relates to Radio Frequency Identification systems, and more specifically to material conveyance devices with actively powered RFID tags.

RFID tags are used in a variety of different applications including: passports, transportation payment systems (e.g., electronic passes), access control (e.g., smart cards), animal identification (e.g., implantable chips), and item tracking. However, supply chain management is potentially one of the most promising applications for RFID tags. Supply chain managers can use RFID tags to track products as they are being manufactured, distributed, and sold. Moreover, RFID tags can be used to quickly and efficiently perform inventories and conduct audits.

A RFID system is typically composed of tags and tag readers. A tag reader communicates with the tags by either selecting specific tags to communicate with, probing the surrounding area for tags, or in the case of tags with high level functionality (i.e., environmental monitoring), querying the tag regarding its environmental conditions.

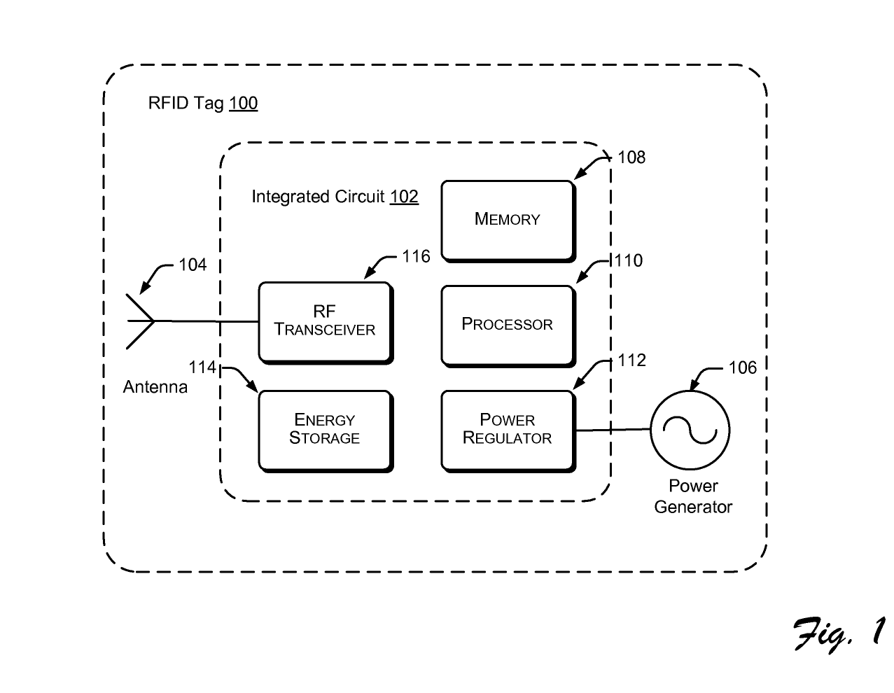

FIG. 1 illustrates an actively powered RFID tag 100 in accordance with an embodiment. The RFID tag 100 could be attached to a product (e.g., library book, apparel, access badge, or pharmaceutical item, to name a few), a material conveyance device (e.g., cart, pallet, dolly, roll-a-way, etc.), or any other suitable device or component.

The RFID tag 100 may include an integrated circuit 102, an antenna 104 for communicating with a tag reader, and a power generator 106 for powering the tag 100. The integrated circuit 102 contains a memory device 108, a micro-processor 110, a power regulator 112, an energy storage device 114, and an RF transceiver 116 for communicating with a tag reader.

The antenna 104 could be in a number of configurations and sizes depending upon the specific application and frequency used to communicate with the tag reader. For example, the RFID tag 100 may employ a dipole antenna when transmitting at a high frequencies (e.g., 13.56 MHz).

The power generator 106 converts mechanical energy into electrical energy which maybe used to recharge the energy storage device 114 and/or power the tag 100 directly.

Generators, alternators and other power generating devices typically employ electromagnetic induction to convert mechanical energy into electrical energy. Normally, a rotating magnet, typically called the “rotor”, turns within a stationary set of conductors wound in the shape of a coil, typically called the “stator”. As the rotor turns relative to the stator, a magnetic field cuts across the stators conductors and generates an electrical current. The alternating current (AC) output may then be presented to a diode bridge which rectifies the AC output to a direct current (DC) output.

The power generator 106 could employ conventional electromagnetic induction to convert mechanical energy into electrical energy. This could include the rotational energy created by a rotating wheel (e.g., castor, truck, or other wheel like device), linear energy created by moving mass (e.g., mass suspended by spring), angular energy also created by a moving mass (e.g., mass suspended by pendulum), or any other suitable source of mechanical energy. Alternatively, the generator could employ piezoelectric materials (e.g., crystals and ceramics) to generate an electrical potential by subjecting the piezoelectric materials to mechanical stress.

Having discussed the antenna 104 and power generator 106, the discussion will now shift to the integrated circuit 102. As noted, the integrated circuit 102 contains a memory device 108, a micro-processor 110, a power regulator 112, an energy storage device 114, and an RF transceiver 116.

The memory device 108 stores information regarding the RFID tag 100, as well as the item that the RFID tag 100 is attached (e.g., product, component, assembly, or material conveyance device, to name a few). For example, the memory device 108 could store a unique identification number associated with the tag, the quantity of energy stored by the storage device 114, the type and quantity of material being conveyed, the material's lot number, the material's expiration date, the transport environment, or any other suitable data or information.

The micro-processor 110 manages the communications with the reader, monitors the state of the energy storage device 114, and reads and writes data to memory 108. For example, if the energy level of the storage device 114 falls below a threshold value, the micro-processor 110 may warn the tag reader that it may no longer be able to communicate with the tag reader. Alternatively, if for some reason the power generator 106, power regulator 112, or storage device 114 were not operating properly, micro-processor 110 may warn the tag reader of an existing or impending component failure.

The discussion will now shift to the power regulator 112. A generator's output voltage generally varies directly with the speed that it rotates. Since material conveyance devices are typically moved about at different speeds. A generator which is driven by the movement of the conveyance device will rotate at various speeds, and accordingly its output voltage will vary. A voltage regulator is designed to maintain a constant voltage by comparing the actual output voltage to a fixed reference voltage. If the output voltage is too low, the voltage regulator produces a higher voltage. Conversely, if the output voltage is too high, the voltage regulator produces a lower voltage. In this way, the output voltage is held at a constant voltage. Typical voltage regulators may include linear regulators, switching regulators, silicon controlled rectifiers, or a combination of these (e.g., hybrid regulator).

The power regulator 112 regulates the power produced by the power generator 106 to ensure that the energy storage device 114 is charged properly and not damaged. For example, if the power generator 106 produced an AC current and the energy storage device 114 was a battery, the power regulator 112 could be designed to limit the current by employing a limiting resistor and perform an AC to DC conversion by employing a diode bridge. The power regulator 112 then trickle charges the energy storage device 114 to ensure that the energy storage device 114 is not damaged during charging.

The energy storage device 114 could be a battery, a capacitor, or any other suitable electrical energy storage device. Ideally, the storage device 114 is rechargeable so that the RFID tags 100 operational life can be extended through recharging.

The RF transceiver 116 receives and transmits signals in response to the tag reader. The RF transceiver 116 may include a wake-up circuit for waking up the RFID tag 100 in response to signals from the tag reader, a receiver for receiving and decoding signals from the receiver, and a transmitter for transmitting signals to the tag reader.

The efficiency of a warehouse or production environment could be significantly improved if the materials in the warehouse or production environment could be easily tracked and identified. Specifically, a robust material tracking and identification system could ensure that materials are not misplaced or lost, that they arrive at the proper location on time, and that the proper amount of material is on hand.

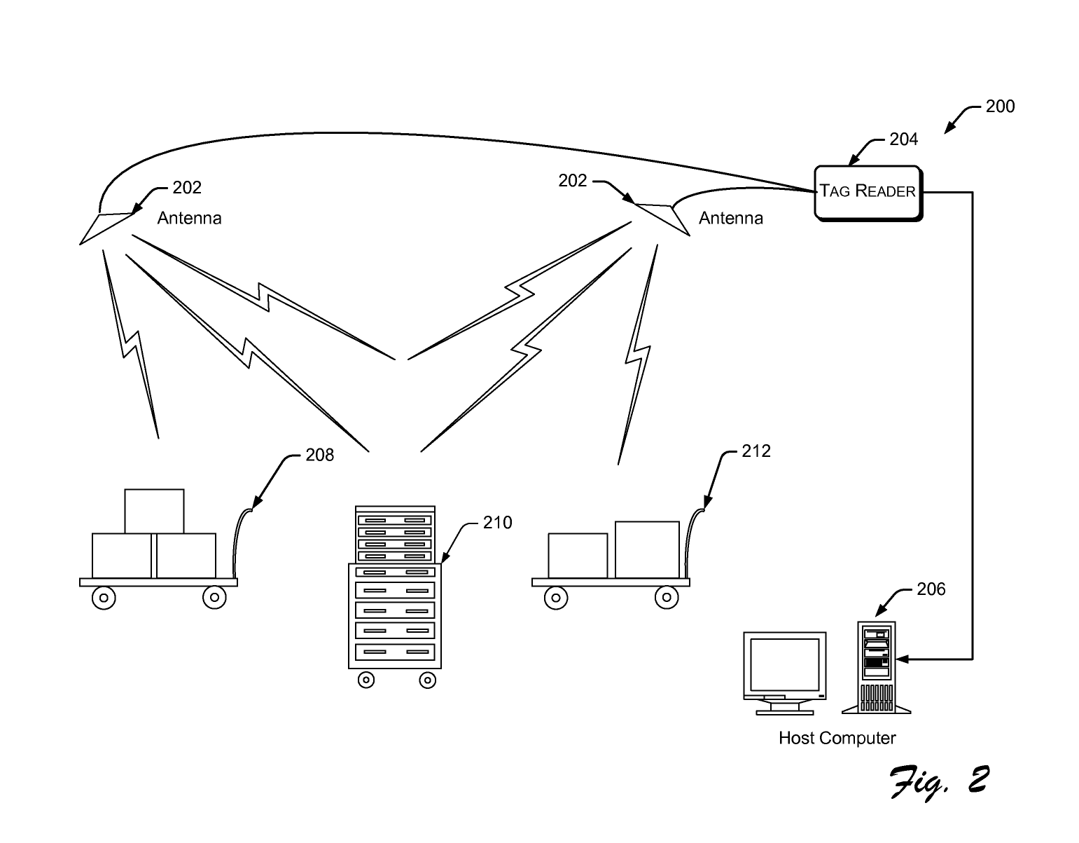

FIG. 2 illustrates a system 200 for tracking the movement of material being transported by one or more material conveyance device(s). The system 100 may include one or more antenna(s) 202, one or more tag reader(s) 204, a host computer 206, and one or more material conveyance device(s) with actively powered RFID tags 208-212.

The antenna(s) 202 transmit and receive signals from the material conveyance device(s) 208-212. The two illustrated antennas are connected to a single tag reader 204, however they could be connected to a separate or independent tag reader(s) 204 depending upon the specific implementation. The antenna(s) 202 are typically positioned or installed to cover a specific region or zone where the material conveyance device(s) 208-212 are located or used (e.g., region of a warehouse or production line). For example, one or more antenna(s) 202 could be positioned in a warehouses entry way, walkway, pass through, or other high traffic area so that when a conveyance device(s) 208-212 enters or leaves the warehouse its presence is detected.

The tag reader 204 detects and communicates with the conveyance device(s) 208-212, and determines the distances between the conveyance devices 208-212 and the antenna(s) 202. For example, the tag reader 204 may transmit an interrogation signal to one or more conveyance device(s) 208-212 and then listen for a response. The conveyance device(s) 208-212 may respond with their unique identification code. The tag reader 204 may receive the unique identification code and determine the identity of the one or more conveyance device(s) 208-212 using lookup table or data base. The lookup table or data base could include other types of information such as: the type and quantity of material being conveyed, the conveyance devices destination, whether the conveyance device is authorized to be in the area, or other information of value. Alternatively, the material conveyance device(s) 208-212 and tag reader 204 may employ digital signal processing to communicate directly with one another (e.g., amount of energy stored in energy storage device, status of the power generator, power regulator, and energy storage device). In an alternate embodiment, the conveyance device(s) 208-212 could initiate the communication by transmitting a signal to the tag reader 204 (e.g., on a periodic basis or when it senses movement) and the tag reader 204 could respond.

The host computer 206 communicates with the tag reader 204 through a wired or wireless communications interface. The host computer 206 collects, organizes, and stores the data collected by the tag reader 204. The host computer 206 could be a laptop computer, a personal computer, a server, a work station, a hand held device, or any other suitable computing device. The host computer 206 may also communicate with other computing devices over a communications network, such as a local area network (LAN), a wide area network (WAN), the internet, or any other suitable communications network.

The distance between the individual conveyance device(s) 208-212 and antenna(s) 202 can be calculated based on the time it takes for a signal to be transmitted to the conveyance device 208-212 and when a response is received by the tag reader 204. For example, the tag reader 204 could interrogate each of the conveyance device(s) 208-212 using each of it's antennas 202, and based on the transmission time determine the distance between each of the conveyance devices 208-212 and the antennas 202. The tag reader 204 could then triangulate the various distances to calculate the position of each conveyance device 208-212.

In an alternate embodiment, the material conveyance device(s) 208-212 include one or more sensors (e.g., proximity sensors, contact sensors, mass sensors, thermal sensors, to name a few) to determine if individual parts, components, or assemblies have been consumed or removed from the material conveyance device 208-212. The sensed information could be stored for subsequent transmission or broadcast real-time by the material conveyance device(s) 208-212 to the tag reader 204. The tag reader 204 could compile and processes the information and relay it to the host computer 206. Alternatively, the tag reader 204 could convey the raw information to the host computer 206 and the host computer 206 could compile and process the information. The host computer 206 could then send the processed information over a LAN, a WAN, a wireless communications network, a phone line, or any other suitable communications network, to part suppliers, material schedulers, or material buyer for further action.

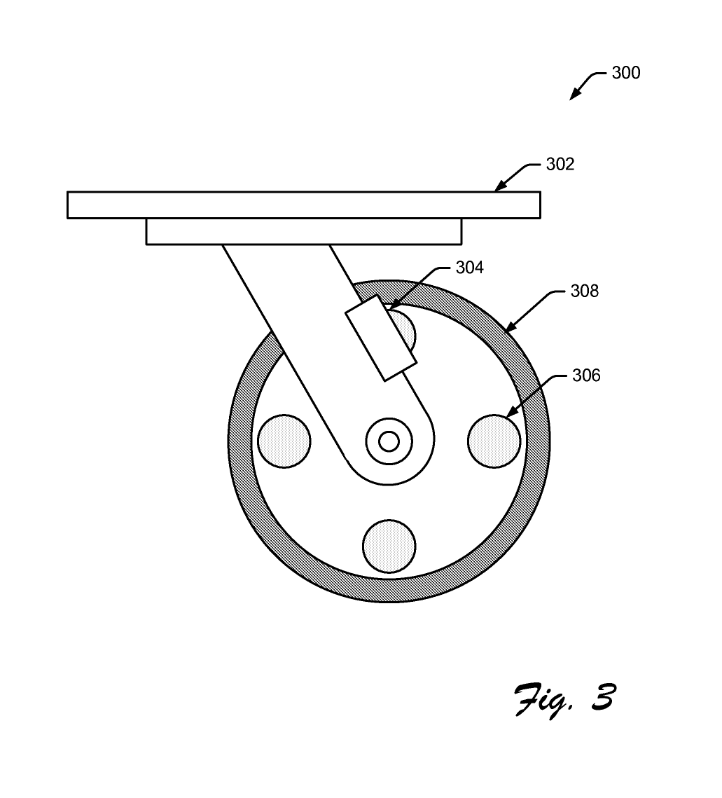

FIG. 3 illustrates an actively powered RFID tag 300 that could be used to track material as it conveyed from one location to another. The RFID tag 300 includes a wheel assembly 302, a radio frequency identification RFID device 304 and one or more magnets 306 that are attached to a wheel 308. The RFID tag 300 could be attached to material conveyance devices which are used to transport materials, products, or assemblies, just to name a few.

As the material conveyance device 208-212 is moved from one location to another, the wheel 308 rotates and the magnet(s) 306 sweep past the RFID device 304. The rotating magnets 306 emit an electromagnetic field which induces an electrical current in a wire or coil residing in the RFID device 304. The AC output maybe rectified (converted) to a DC output by a diode bridge and the DC output regulated based on the requirements of the RFID device 304. The regulated DC output is then used to either recharge an energy storage device residing in the RFID device 304 or directly power the device. Alternatively, the magnet(s) 306 could be stationary and the RFID device 304 could rotate relative to the magnet(s) (e.g., the RFID device 304 could be coupled to wheel 308).

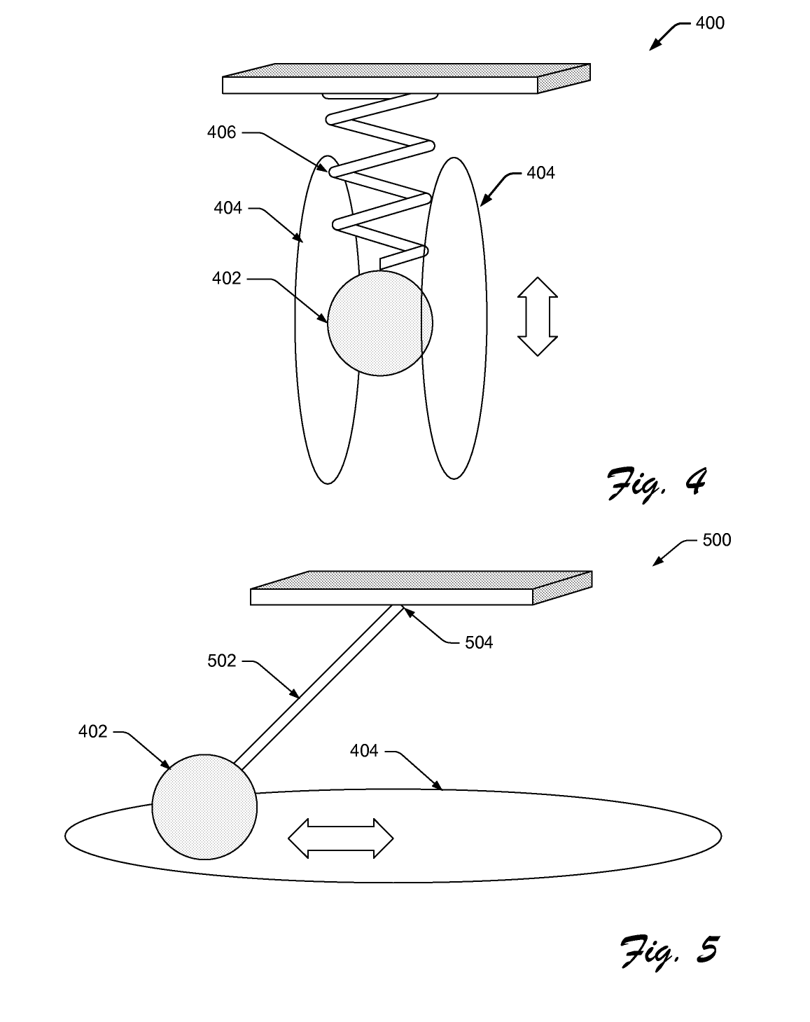

In addition to rotational motion, linear and angular motion could be converted into electrical energy and used to power the RFID device 304. FIGS. 4 and 5 illustrate electrical generators which maybe used to covert linear and angular motion/vibration into electrical energy.

FIG. 4 illustrates a linear motion generator 400 which includes a magnetic mass 402 (e.g., rotor), one or more stationary coils 404 (e.g. stator), and a spring 406. Like a conventional electrical generator, the linear motion generator 400 converts the magnetic masses 402 linear motion into electrical energy by inducing an electric current in the stationary coils 404. For example, the linear motion generator 400 could be attached to a material conveyance device 208-212 such that as it is moved from one location to another, the natural motion and vibration of the conveyance device 208-212 causes the magnetic mass 402 to undulate up and down. This in turn causes the masses 402 magnetic field to move up and down across the stationary coils 404 and generate an electrical current.

FIG. 5 illustrates an angular motion generator 500 which includes a magnetic mass 402, one or more stationary coils 404, and a tether 502 for maintaining the mass 402 in the correct angular position. Like the linear motion generator 400, the angular motion generator 500 converts the magnetic masses 402 linear motion into electrical energy by inducing an electric current in the stationary coils 404. In this instance, the angular motion generator 500 would also be attached to a material conveyance device 208-212, and the conveyance device 208-212 natural motion (e.g., start moving, stop moving, and change of direction) causes the angular motion generator 500 to swing back and forth and generate an electrical current.

Piezoelectric materials (i.e., crystals and ceramics) have the ability to generate an electrical potential in response to mechanical stress. Specifically, when a piezoelectric material is mechanically stressed, there is a separation of electric charge across the materials crystal lattice which induces a voltage across the material. This piezoelectric effect is reversible; accordingly if a piezoelectric material is subjected to multiple stress cycles it will generate electrical energy.

Referring back to FIG. 5, in an alternate embodiment the tether 502 could be replaced with components made of a piezoelectric material. With the tether end 504 rigidly attached, any motion of the mass 402 would induced stress in the piezoelectric material (i.e., tether) which in turn generate electrical energy.

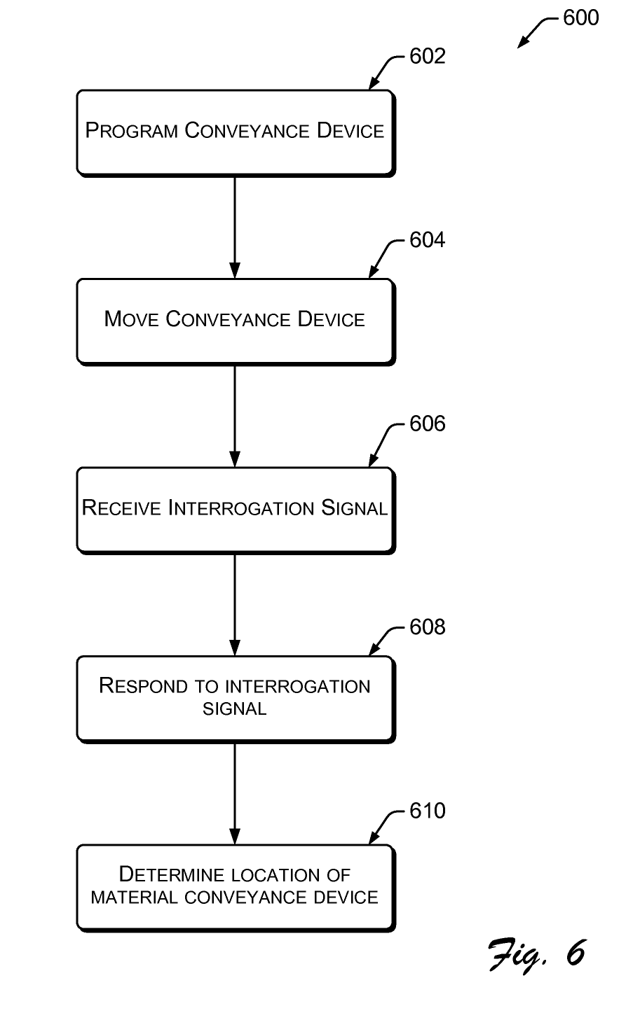

FIG. 6 illustrates a method for determining the location of a material conveyance device in accordance with an embodiment.

An actively powered RFID tag which has been attached to a material conveyance device is programmed, at block 602. The programming could be performed by a hand held device, a personal computer, a server, or any other suitable programming device. The programmed data or information may include a unique identification code, the type and quantify of material being conveyed, the shipper and recipient of the material, the transportation route or delivery location, or any other information of value.

The material conveyance device is then moved to a new location, at block 604. The new location could be a warehouse, a manufacturing area, a stock room, a material staging area, or any other suitable location. When the conveyance device enters the new location, a tag reader could transmit an interrogation signal. Alternatively, the RFID tag could periodically transmit a signal notifying the tag reader of its presence.

The material conveyance device receives the interrogation signal from the tag reader, at block 606. The interrogation signal could be a query asking for the conveyance devices unique identification number or it could simply be a command for the material conveyance to respond.

The material conveyance device then responds to the interrogation signal, at block 608. The response could include the conveyance devices unique identification number, the status or health of the RFID tag, the type and quantity of material being conveyed, the material conveyance devices destination, where the material conveyance devices route, or any other information of value.

If the material conveyance devices exact location is needed (i.e., located in a large warehouse or production facility); it can be determined by triangulating the distances between the various antennas and the conveyance device, at block 610.

Although devices and methods for conveying materials have been described in language specific to certain features and/or methodological acts, it is to be understood that the disclosure is not limited to the specific features or acts described. Rather, the specific features and acts are disclosed as exemplary forms of implementing the disclosure.

What is claimed is:

1. A radio frequency identification device comprising:
an energy storage device for supplying electrical energy to a radio frequency transceiver;
a power generation device for supplying electrical energy to the energy storage device, wherein the power generation device converts kinetic energy into electrical energy; and
a power regulator for regulating the electrical energy generated by the power generation device.

2. A device as recited in claim 1, where in the energy storage device comprises one or more of a rechargeable battery or a capacitor.

3. A device as recited in claim 1, wherein the power generation device employs electromagnetic induction to convert kinetic energy into electrical energy.

4. A device as recited in claim 1, wherein the power generation device employs piezoelectric materials to convert strain energy into electric energy.

5. A device as recited in claim 1, wherein the power regulator converts an AC current to a DC current.

6. A device as recited in claim 1, wherein the power regulator trickle charges the energy storage device.

7. A device as recited in claim 3, wherein the kinetic energy is derived from a wheel.

8. A device as recited in claim 7, wherein the wheel is part of a material conveyance device.

9. A material conveyance device comprising:
a structure for transporting material; and
a radio frequency identification device, the radio frequency identification device comprising:
an energy storage device for supplying electrical energy to a radio frequency transceiver;
a power generation device for supplying electrical energy to the energy storage device, wherein the power generation device converts kinetic energy into electrical energy; and
a power regulator for regulating the electrical energy generated by the power generation device.

10. A material conveyance device as recited in claim 9, wherein the structure for transporting the material comprises one or more of a hand cart, a shopping cart, a dolly, a flat bed cart, a tool box, or a specially designed conveyance

11. A material conveyance device as recited in claim 9, where in the energy storage device comprises one or more of a rechargeable battery or a capacitor.

12. A material conveyance device as recited in claim 9, wherein the power generation device employs electromagnetic induction to convert kinetic energy into electrical energy.

13. A material conveyance device as recited in claim 9, wherein the power generation device employs piezoelectric materials to convert strain energy into electric energy.

14. A material conveyance device as recited in claim 9, wherein the power regulator converts an AC output to a DC output.

15. A material conveyance device as recited in claim 9, wherein the power regulator power trickle charges the energy storage device.

16. A material conveyance device as recited in claim 12, wherein the kinetic energy is derived from a wheel and the wheel is used to move the material conveyance device

17. A method for tracking material being transported by a material conveyance device, comprising:
receiving an interrogation signal; and
transmitting a signal in response to the interrogation signal, wherein the signal is transmitted by the material conveyance device, the material conveyance device comprising:
a power generation device for converting kinetic energy into electrical energy; and
a radio frequency transceiver for receiving the interrogation signal and transmitting the signal using electrical energy generated by the power generation device.

18. A method as recited in claim 17, further comprising determining the position of the material conveying device based on the transmitted signal and location of one or more antennas that received the transmitted signal.

19. A method as recited in claim 17, wherein the material conveyance device further comprises an energy storage device, and the transmitted signal indicates an amount of energy stored in the energy storage device

20. A method as recited in claim 17, wherein the material conveyance device further comprises a sensor for sensing whether transported material has been removed from the material conveyance device, and the transmitted signal indicates whether the transported material has been removed from the material conveyance device.
